(19) United States
(12) Patent Application Publication
(10) Pub. No.: US 2012/0109645 A1
(43) Pub. Date: May 3, 2012

(54) DSP-BASED DEVICE FOR AUDITORY SEGREGATION OF MULTIPLE SOUND INPUTS

(75) Inventors: John Hallam, Odense SV (DK); Jakob Christensen-Dalsgaard, Odense M (DK)

(73) Assignee: LIZARD TECHNOLOGY, Odense M (DK)

(21) Appl. No.: 13/380,980

(22) PCT Filed: Jun. 23, 2010
(86) PCT No.: PCT/DK2010/050156

§ 371 Date: Dec. 27, 2011

Related U.S. Application Data
(60) Provisional application No. 61/220,602, filed on Jun. 26, 2009.

(51) Int. Cl. G10L 11/04

(52) U.S. Cl. 704/207; 704/E11.006

(57) ABSTRACT

There is provided a unique signal processing technique for localizing and characterizing each of a number of differently located acoustic sources. Specifically there is provided a method for auditory segregation of multiple voice inputs comprising the steps of: receiving a plurality of voice input signals from different source locations; filtering said voice input signals with head related transfer functions (HRTF) using a digital signal processor (DSP) thereby assigning the voice input signals to different locations in virtual auditory space; and changing the HRTF filtered voice input signals in two dimensions, wherein pitch is changed and the signal is filtered with different filters emulating vocal tracts of different sizes thereby further segregating the voice input signals from each other.

### FIELD OF THE INVENTION

The invention relates to communication systems and more particularly to multi-talker communication systems using spatial processing.

### BACKGROUND OF THE INVENTION

In communication tasks that involve more than one simultaneous talker, substantial benefits in overall listening intelligibility can be obtained by digitally processing the individual speech signals to make them appear to originate from talkers at different spatial locations relative to the listener. In all cases, these intelligibility benefits require a binaural communication system that is capable of independently manipulating the audio signals presented to the listener's left and right ears. In situations that involve three or fewer speech channels, most of the benefits of spatial separation can be achieved simply by presenting the talkers in the left ear alone, the right ear alone, or in both ears simultaneously. However, many complex tasks, including air traffic control, military command and control, electronic surveillance, and emergency service dispatching require listeners to monitor more than three simultaneous systems. Systems designed to address the needs of these challenging applications require the spatial separation of more than three simultaneous speech signals and thus necessitate more sophisticated signal-processing techniques that reproduce the binaural cues that normally occur when competing talkers are spatially separated in the real world. This can be achieved through the use of linear digital filters that replicate the linear transformations that occur when audio signals propagate from a distant sound source to the listener's left or right ears. These transformations are generally referred to as head-related transfer functions, or HRTFs.

If a sound source is processed with digital filters that match the head related transfer function of the left and right ears and then presented to the listener through stereo head-phones, it will appear to originate from the location relative to the listener's head where the head-related transfer function was measured. Prior research has shown that speech intelligibility in multi-channel speech displays is substantially improved when the different competing talkers are processed with head-related transfer function filters for different locations before they are presented to the listener.

In practice, the methods used to implement spatial processing in a multi-channel communication system depend on the architecture used in that system. The basic objective of a multi-channel communications system is to allow each of a number of users to choose to listen to any combination of a number of input communications channels over a designated audio display device (usually a headset).

WO 06/039748A1 discloses a method to process audio signals. The method includes filtering a pair of audio input signals by a process that produces a pair of output signals corresponding to the results of filtering each of the input signals with a HRTF filter pair, and adding the HRTF filtered signals. The HRTF filter pair is such that a listener listening to the pair of output signals through headphones experiences sounds from a pair of desired virtual speaker locations. Furthermore, the filtering is such that, in the case that the pair of audio input signals includes a panned signal component, the listener listening to the pair of output signals through headphones is provided with the sensation that the panned signal component emanates from a virtual sound source at a centre location between the virtual speaker locations.

U.S. Pat. No. 5,742,689 discloses a method to process multi-channel audio signals, each channel corresponding to a loudspeaker placed in a particular location in a room, in such a way as to create, over headphones, the sensation of multiple “phantom” loudspeakers placed throughout the room. Head Related Transfer Functions (HRTFs) are chosen according to the elevation and azimuth of each intended loudspeaker relative to the listener, each channel being filtered with an HRTF such that when combined into left and right channels and played over headphones, the listener senses that the sound is actually produced by phantom loudspeakers placed throughout the “virtual” room.

WO 99/14983A1 discloses an apparatus for creating utilizing a pair of oppositely opposed headphone speakers, the sensation of a sound source being spatially distant from the area between the pair of headphones, the apparatus comprising: (a) a series of audio inputs representing audio signals being projected from an idealised sound source located at a spatial location relative to the idealised listener; (b) a first mixing matrix means interconnected to the audio inputs and a series of feedback inputs for outputting a predetermined combination of the audio inputs as intermediate output signals; (c) a filter system of filtering the intermediate output signals and outputting filtered intermediate output signals and the series of feedback inputs, the filter system including separate filters for filtering the direct response and short time response and an approximation to the reverberant response, in addition to the feedback response filtering for producing the feedback inputs; and (d) a second matrix mixing means combining the filtered intermediate output signals to produce left and right channel stereo outputs.

US20080187143A1 discloses a system and method for providing simulated spatial sound in group voice communication sessions on a wireless communication device is provided. The wireless communication device is one of two or more in the system which are operatively connected to a wireless communications network.

U.S. Pat. No. 7,391,876 discloses a method for simulating a 3D sound environment in an audio system using an at least two-channel reproduction device, the method including generating first and second pseudo head-related transfer function (HRTF) data, first using at least one speaker and then using headphones; dividing the first and second frequency representation of the data or using a deconvolution operator on the time domain representation of the first and second data, or subtracting the representation of the first and second data, and using the results of the division or subtraction to prepare filters having an impulse response operable to initiate natural sounds of a remote speaker for preparing at least two filters connectable to the system in the audio path from an audio source to sound reproduction devices to be used by a listener. Meanwhile, the document does not provide a segregation of sound sources as in the present invention. Accordingly, the present invention appears to be novel and involve an inventive step over this prior art document.

In sound systems involving sound inputs from e.g. 4-8 different lines, all delivered through the same headphone set, it is sometimes insufficient to apply a spatialization of the sound sources in order for the listener to distinguish the sound inputs. Thus, there is a need to further improve the prior art methods and systems to overcome this problem.

### SUMMARY OF THE INVENTION

The present inventors have surprisingly found that segregation of voices may be implemented by using a digital signal processor (RM2, Tucker-Davis technology) that can receive up to eight input channels. By changing the pitch (resampling) and vocal tract quality (filtering) the voice quality is changed, then the signal is assigned a definite location in virtual space by HRTF filtering (using a custom set of HRTF coefficients) and emitted using stereo headphones. The signal manipulation is performed real-time. This separation greatly increases intelligibility of multiple signals, as measured by the ability to follow one channel.

Thus, the sound system of the present invention receives sound inputs from 4-8 different lines, all delivered through the same headphone set. Each line is filtered on-line with a different HRTF using a digital signal processor (DSP) and is thereby assigned to a different location in virtual auditory space. In addition the voice quality is changed in two dimensions: the pitch is changed and the signal is filtered with different filters emulating vocal tracts of different sizes. This operation can change male to female voices, and thus generate a different voice quality for each channel.

Specifically the present invention provides a method for auditory segregation of multiple voice inputs, said method comprising the steps of:
receiving a plurality of (real or artificial) voice input signals;
changing each voice input signals in two dimensions, wherein pitch is changed and the signal is filtered with filters emulating vocal tracts of different sizes, thereby further segregating the voice input signals from each other.
filtering said processed voice input signals with head related transfer functions (HRTF) using a digital signal processor (DSP) thereby assigning the voice input signals to different locations in virtual auditory space;

In a preferred embodiment of the present invention the head related transfer function (HRTF) spatial configuration step further comprises the step of applying automatic gain control to each of said plurality of voice input signals.

In another preferred embodiment the head related transfer function (HRTF) spatial configuration step further comprises the step of system operator controlling relative levels of said voice input signals thereby providing the capability to amplify a single, important voice input signal.

In still another preferred embodiment method involves a localization operator responsive to delayed signals to localize the interfering sources relative to the location of the sensors and provide a plurality of interfering source signals each represented by a number of frequency components. The method further includes an extraction operator that serves to suppress selected frequency components for each of the interfering source signals and extract a desired signal corresponding to a desired source. An output device responsive to the desired signal may also be included that provides an output representative of the desired source. This system may be incorporated into a signal processor coupled to the sensors to facilitate localizing and suppressing multiple noise sources when extracting a desired signal.

Still another embodiment of the present invention is responsive to position-plus-frequency attributes of sound sources. It includes positioning multiple acoustic sensors to detect a plurality of differently located acoustic sources. Multiple signals are generated by the multiple sensors, respectively, that receive stimuli from the acoustic sources. A number of delayed signal pairs are provided from the first and second signals that each correspond to one of a number of positions relative to the first and second sensors. The sources are localized as a function of the delayed signal pairs and a number of coincidence patterns. These patterns are position and frequency specific, and may be utilized to recognize and correspondingly accumulate position data estimates that map to each true source position. As a result, these patterns may operate as filters to provide better localization resolution and eliminate spurious data.

In yet another embodiment the method includes multiple sensors each configured to generate a corresponding first or second input signal and a delay operator responsive to these signals to generate a number of delayed signals each corresponding to one of a number of positions relative to the sensors. The system also includes a localization operator responsive to the delayed signals for determining the number of sound source localization signals. These localization signals are determined from the delayed signals and a number of coincidence patterns that each correspond to one of the positions. The patterns each relates frequency varying sound source location information caused by ambiguous phase multiples to a corresponding position to improve acoustic source localization. The system also has an output device responsive to the localization signals to provide an output corresponding to at least one of the sources.

A further form utilizes two sensors to provide corresponding binaural signals from which the relative separation of a first acoustic source from a second acoustic source may be established as a function of time, and the spectral content of a desired acoustic signal from the first source may be representatively extracted. Localization and identification of the spectral content of the desired acoustic signal may be performed concurrently. This form may also successfully extract the desired acoustic signal even if a nearby noise source is of greater relative intensity.

Another form of the present invention employs a first and second sensor at different locations to provide a binaural representation of an acoustic signal which includes a desired signal emanating from a selected source and interfering signals emanating from several interfering sources. A processor generates a discrete first spectral signal and a discrete second spectral signal from the sensor signals. The processor delays the first and second spectral signals by a number of time intervals to generate a number of delayed first signals and a number of delayed second signals and provide a time increment signal. The time increment signal corresponds to separation of the selected source from the noise source. The processor generates an output signal as a function of the time increment signal, and an output device responds to the output signal to provide an output representative of the desired signal.

Accordingly, it is one object of the present invention to provide for the enhanced localization of multiple acoustic sources.

It is another object to extract a desired acoustic signal from a noisy environment caused by a number of interfering sources.

Further embodiments, objects, features, aspects, benefits, forms, and advantages of the present invention shall become apparent from the detailed drawings and descriptions pro- vided herein.

### DETAILED DESCRIPTION OF THE INVENTION

The essence of the invention is that a signal is modified in three steps. The first step is conversion of pitch, the next the conversion of mouth cavity resonances and the third the location of the signal in virtual space. The processing in each of the steps will be detailed below. The major constraint is that the processing should be performed real-time. This does not necessarily exclude previous measurement e.g. of vocal tract characteristic of a speaker, but does constrain the signal processing. Also, there will necessarily be a delay between signal input and output. It should, however, be less than approximately 100 milliseconds.

The following operations are performed on each input channel in parallel: Note that the operations described are meant as examples only and that other realizations of the processing steps (other algorithms for changing pitch or vocal tract resonances, for example) are within the scope of the invention.

1. Conversion of pitch. The pitch will in the simplest version be shifted by real-time multiplication by a cosine carrier signal with the shift frequency (f+f0) as argument. The function of this is to shift all frequencies by f+f0. The multiplication also generates the component f-f0, which will be removed by appropriate digital filtering (high-pass, at the frequency f). The effect is that the signal is pitch shifted upward by the frequency f0. may be implemented by resampling the input signal at a new sampling frequency, followed by interpolation, working on short segments (e.g. 50 ms) of the signal. This is the simplest algorithm for pitch shifting; there are other, more sophisticated algorithms (such as the Lent pitch shifter, U.S. Pat. No. 5,969,282; see also Lent 1989) that also work real-time.

2. Vocal tract resonances are measured during a short calibration session (few seconds) and used to deconvolute the signal (by creating a digital filter) . Subsequently, the signal is filtered by a new vocal tract characteristic

3. Placement of the processed signal in virtual space is done by filtering with the appropriate head related transfer functions. HRTFs are realized as sets of filter coefficients for a digital filter, one set for each sound location. Filtering a monaural signal with the appropriate HRTFs simulates the filtering of sound by the listener's head and external ear and generates a stereo signal that gives the impression of sound location when played over stereo headphones. Ideally, these HRTFs should be measured individually (by measuring the sound in the ear canal for many different free-field sound locations), but our pilot experiments show that a robust virtual sound location can be generated also with a standard set of HRTFs.

4. The output of this operation is a stereo signal for each input channel. The stereo signals are mixed and presented to a listener using stereo headphones.

References: Lent K (1989) An efficient method for pitch shifting digitally sampled sounds. Computer Music J 13: 65-71

1. A method for auditory segregation of multiple voice inputs, said method comprising the steps of:
receiving a plurality of voice input signals;
changing said voice input signals in two dimensions, wherein pitch is changed and the signal is filtered with one or more filters emulating vocal tracts of different sizes thereby further segregating the voice input signals from each other;
filtering said voice input signals with head related transfer functions (HRTF) using a digital signal processor (DSP) thereby assigning the voice input signals to different locations in virtual auditory space.

2. The method of claim 1, wherein the head related transfer function (HRTF) spatial configuration step further comprises the step of applying automatic gain control to each of said plurality of voice input signals.

3. The method of claim 1, wherein the head related transfer function (HRTF) spatial configuration step further comprises the step of system operator controlling relative levels of said voice input signals thereby providing the capability to amplify a single, important voice input signal.

4. The method of claim 2, wherein the head related transfer function (HRTF) spatial configuration step further comprises the step of system operator controlling relative levels of said voice input signals thereby providing the capability to amplify a single, important voice input signal.
